(19) United States
(12) Patent Application Publication
(10) Pub. No.: US 2008/0083750 A1
(43) Pub. Date: Apr. 10, 2008

(54) Microwave oven thawing tray for foodstuff

(76) Inventor: Yamil Adiv Maccise Sade, Cancun Quintana Roo (MX)

Correspondence Address: Welsh & Katz, Ltd.;Daniel M. Gurfinkel, 22nd Floor, 120 South Riverside Plaza, Chicago, IL, 60606, US

(21) Appl. No.: 11/510,426

(22) Filed: Aug. 24, 2006

(51) Int. Cl. H05B 6/80

(52) U.S. Cl. 219/725

(57) ABSTRACT

This invention refers to the industrial area of manufacture of microwave oven accessories for thawing foodstuff in different compartments in response to the incidence of microwave ovens. Furthermore, this invention can also be applied in the industry of packages for frozen foodstuff. Advantages of the foregoing invention regarding trays of the prior art include allowing thawing of raw ingredients in the recopies without cooking them and thawing of cooked ingredients without changing their consistency; with a faster thawing operation; with ease of manufacture; whose cover can be easily detached from the rest of the container without having any kind of adhesive; that allows to easily hold sushi rolls with chopsticks; allowing microwave generated heat to go from one cavity to the next. This tray is characterized by comprising a lower base named tray and a thermosealed cover around the edges where they converge; both elements are made of materials with low microwave generated heat, specifically materials made of polyester resins such as CPET (tray) and film (cover).

### FIELD OF THE INVENTION

This invention refers to the industrial area of manufacture of microwave oven accessories for thawing foodstuff in different compartments in response to the incidence of microwave ovens. Furthermore, this invention can also be applied in the industry of packages for frozen foodstuff.

### BACKGROUND OF THE INVENTION

Packages that allow for easy thawing of the products contained therein are often needed. There are various ways to thaw a product, one of them includes leaving the product at room temperature until it thaws, another one includes setting the product under cold water for the same operation, it is also possible to thaw such products with warm water of other heat source, where the temperature difference between the heat source and the product to be thawed allows for a significant heat exchange.

At this time, with the proliferation of microwave ovens and the advantages these ovens offer regarding the efficiency to transform microwave energy into caloric energy, a need to provide packages with certain characteristics for a proper behavior during thawing processes has risen.

The behavior of different materials under microwave run has driven a series of investigations to determine which materials are the most appropriate for a package that will also be useful for thawing products contained therein.

Furthermore, is materials conforming these packages have been investigated for their behavior under microwave run, it is known that ultimately foodstuff is heated because the water molecule in liquid state increases its vibration due to the microwaves. This is what makes foodstuff get warmer due to microwaves.

Without the effect of some susceptor, browning of any foodstuff cannot be done, whether meat, bread, or any other foods. Nor will it be feasible to reach corn popping temperatures to make pop corn without these susceptors.

In the problem when thawing, the differences in characteristics of any meal's components can make thawing in some components deficient and can cook or overcook some other components.

This is because some meals have components with various water contents, while other meals have components that are already cooked and some components that must be packed raw.

Because these various components have different water contents, and water molecules are the ones that get activated in order to get warmer, some components will be left hard and leathery as the result of the microwave run, while others will be cooked, and yet other will not be completely thawed.

There are numerous packages with the qualities described above for thawing of foodstuff, such as the ones disclosed in U.S. Pat. No. 6,844,536, U.S. Pat. No. 4,794,008, and various U.S. more.

WO 03/016171, FR 02 05862, CA 2,417,450, and EP 1,279,605 are also related.

Some patents disclose packages on which thawing is achieved without the package bursting open thus causing some damage to the oven or even those handling such packages for thawing.

Some packages solve the above by providing a cover with two types of materials, a core portion that is rigid and a peripheral one with certain resiliency.

Based on an analysis of the various trays used for packaging of frozen foodstuff, and also designed to thaw such foodstuff with cooked components and raw components, such as sushi, by microwave, one may note that such packages have in at least their bases a metallic sheet to reflect the microwaves.

These packages have the disadvantage of requiring complex manufacture in order to introduce this metallic sheet, and furthermore they do not control the unfavorable effect microwaves have on raw products.

There are also packages with materials of characteristics that may cause significant changes on the packaged foodstuff, or have a short shelf life, which delays the thawing operation.

### OBJECTIVES OF THE INVENTION

One objective of this invention is to provide a package for frozen meals like sushi that will allow thawing of the raw components without cooking them, and thawing of cooked components without altering their consistency.

Another objective is to make possible a package with the qualities above that will also make this thawing operation faster.

Yet another objective it to make possible a package whose cover can easily be detached from the rest of the package without contamination caused in the foodstuff with any type of adhesive.

Another objective of this invention is to make possible a tray with a design that allows for easy holding of sushi rolls with Japanese chopsticks, allowing the steam that may be generated during thawing to flow from one compartment to another.

Other objectives and advantages of this foregoing invention may become apparent from the study of the following description, where basic qualities of this package are detailed.

### BRIEF DESCRIPTION OF THE INVENTION

In brief, this invention consists of a tray made of special materials with low absorbency for microwave generated heat, with rigid qualities that allow for handling during thawing of ingredients of meals such as sushi.

This tray has cavities that hold the different foods to be thawed. The shape of these cavities depends on the type of foodstuff. For instance, in the case of sushi, we have three types thereof: Nigiri sushi, which is a ball of rice (prepared with vinegar, sugar, salt) with a thin slice of raw fish or vegetables on top thereof; Maki sushi, which is a roll of prepared rice, wrapped with sea weed and filled with raw fish or sea food portions and/or vegetables; and Guncan, which is a ball of prepared rice, wrapped by sea weed, and filled with any type of fish eggs.

Aside from the shape due to the actual type of sushi, it includes a few channels to communicate the microwave generated heat among the various cavities. In the compartments for sushi rolls (Maki sushi), vertical slots are set on opposite ends, and Japanese chopsticks may be inserted therein to hold said sushi rolls.

This package is complemented by a cover consisting of a plastic material film that also has completely low microwave generated heat absorbency, and which makes them penetrate evenly, spreading between the cover and the bottom of the tray.

Attachment between the cover and this tray is achieved through thermo-seals on areas where the upper edge of the tray and the cover converge.

It is important to note that for this structure to work the foodstuff must have been subjected to a quick freeze in order to decrease the size of frozen water crystals, providing the microwaves with a much larger specific contact surface. This is characteristic usually found on frozen products.

In order to achieve all objectives listed herein, materials must also have certain degree of rigidity. Semi-rigid in the base and flexible in the cover.

Following numerous tests it was determined that the best material, for its low microwave generated heat absorbency, is polyester resins. Specifically, the material found to have optimum qualities is the one known in the market as CPET, thermoplastic of crystallized polyethylene terepthalate. CPET is extruded in sheets that are then subject to a high temperature thermoforming process, and once in the shape of a tray with its resistance to high temperatures provides an unquestionable advantage to avoid absorption of a great amount of heat while on the microwave run, which would cause the sushi to burn or cook, causing thus serious damage to the thawing process.

The film (cover), in one of its embodiments, is a co-extrusion of the polyester resin whose chemical composition is polyethylene terepthalate which in contact with microwaves and during the brief period of time in which we use it, does not absorb heat quantities that could damage the sushi's integrity by burning and cooking it. As mentioned above, the bond between the tray and the cover is achieved by thermosealing, without the use of any adhesive that could later become loose and then form part of the foodstuff, thus contaminating it.

Another embodiment of the film consists of a film whose main ply is made of dual orientation polyester, but it contains various plies laminated to such polyester, as follows:
*plies laminated onto the polyester:*
*evoh:* ethylene-vinyl alcohol
*polyamide: (nylon)*
*polyolefin: *ethylene copolymer

The simple fact of having the thawing package or tray and tray made of a material that absorbs little microwave generated heat means a significant advancement from the prior art, however, more specifically, providing the art with these better materials comprised of polyester resins, specially CPET, means a more specific advancement. It was surprisingly discovered that this type of material not only achieved homogeneous thawing of different ingredients, but it also allowed reducing the thawing process time.

To allow for a better understanding of the characteristics of the foregoing invention, this description includes, as an integral part hereof, drawings with illustrative, and not limitative, character, as described below.

### BRIEF DESCRIPTION OF THE DRAWINGS

FIG. 1 is a conventional perspective view of the tray including two types of sushi;

FIG. 2 is a conventional perspective view of the tray including only one Maki sushi;

A detailed description of some of the embodiments of this translation is given below to provide a better understanding hereof, with reference to the drawings attached hereto with illustrative, not limitative, purposes.

### DETAILED DESCRIPTION OF THE INVENTION

Characteristic details of this novel foodstuff thawing tray will be shown in the detailed description of the embodiment shown in the attached drawings, indicating the same parts thereof with the same reference signs.

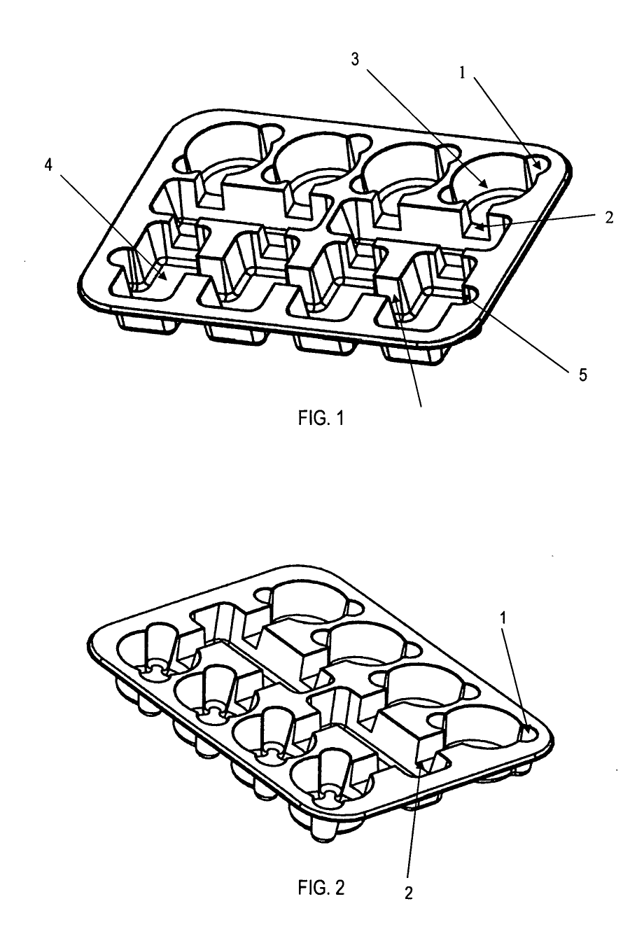

FIG. 1 shows a conventional perspective view of the tray including two types of sushi; Maki sushi is deposited in cavities 3 and the other type of sushi may be deposited in cavity 5.

Cavities 3 where Maki sushi is deposited have vertical slots 1 where Japanese chopsticks used to take the sushi rolls are introduced. Regarding the other cavities 5, they also have vertical slots 4 to hold other types of sushi.

Maki containing cavities have passages 2 and passages 6 for other types of sushi in order to allow for the microwave generated heat to enter each cavity.

In other aspects of our invention, in more detail, our invention consists of a package formed by a base, also called tray, and a cover conformed by a plastic film, both are low microwave generated heat absorbents, and which make these microwaves penetrate evenly, being distributed between the cover and the lower end of the tray.

The film is selected for its low heat absorbing qualities, and serves as a lid, and is thermally sealed around the tray edges prior to the air extraction. One advantage of this film is that it is easy for the end consumer to open and further does not contain any adhesive that could contaminate foodstuff.

The tray is made of CPET, which is extruded in sheets that are then subject to a high temperature thermoforming process, which once in the shape of a tray with its resistance to high temperatures provides an unquestionable advantage to avoid absorption of a great amount of heat while on the microwave run, which would cause the sushi to burn or cook, causing thus serious damage to the thawing process.

The film (cover) is a co-extrusion of the polyester resin whose chemical composition is polyethylene terepthalate which in contact with microwaves and during the brief period of time, in which we use it, does not absorb heat quantities that could damage the sushi's integrity by burning and cooking it. It is a biaxial polyester film with a thermosealed amorphous polyester ply, an excellent barrier for oxygen, carbon dioxide, and water, with high resistance to high and low temperatures, and microwave radiations do not interact with this polyester film.

This invention comprises another embodiment of the film, consisting of a film whose main ply is made of dual orientation polyester, but it further contains various plies laminated to such polyester, as follows:
*evoh:* etylene-vynil alcohol
*polyamide: (nylon)*
*polyolefin: *ethylene copolymer

It was then possible to determine that the two materials with the best performance to achieve thawing in a microwave oven, for foodstuff such as sushi, are CPET (tray) and polyester film (cover), with a higher or lower number of plies of the same or different materials.

This CPET made tray is thicker than the cover, and has a thermal treatment applied when the cavities where the components of the meal are to be placed, for example, for sushi, precooked rice, raw fish, and also raw vegetables.

In one of its embodiments, this tray may comprise a black dye in its materials in order to avoid interaction of ultraviolet light and the foodstuff.

Our CPET is extruded with a double structure of the same CPET material in order to increase rigidity and resistance to high temperatures (when subjected to microwaves for thawing), and increases its resistance to impacts when subjected to very low temperatures (minus 21° C.); this is temperature that preserves sushi in the tray.

This invention has been described with details enough so that those skilled in the art may reproduce it and get the results stated herein. However, any person skilled in the art of this present invention may do non-described modifications thereto but if the application of such modifications in a given structure or its manufacture process requires the subject matter included in the following claims, such structures shall be included in the scope of this invention.

1. Tray for microwave thawing of foodstuff, characterized by comprising a lower base named tray and a thermosealed cover around the edges where they converge; both elements are made of resins with low absorbance of microwave generated heat, specifically resins selected from a set of various polyesters, and particularly one known as CPET in the art.

2. Tray for microwave thawing of foodstuff per claim 1, characterized by the material commonly known as CPET (crystallized polyethylene terepthalate).

3. Tray for microwave thawing of foodstuff per claim 1, characterized by the film of the polyester cover being a biaxial polyester film with a amorphous thermosealed polyester ply, an excellent barrier for oxygen, carbon dioxide, and water, high resistance to high and low temperatures, and microwave radiations do not interact with this polyester film.

4. Tray for microwave thawing of foodstuff per claim 3, characterized by having its main ply made of dual orientation polyester and other plies laminated thereto:
*evoh:* etylene-vynil alcohol
*polyamide: (nylon)*
*polyolefin: *ethylene copolymer

5. Tray for microwave thawing of foodstuff per claim 1, characterized by the cavities where the foodstuff will be placed having two vertical slots in order to introduce the Japanese chopsticks and to make holding sushi easier, and communication channels to and from adjacent cavities that allow for heat communication between them.

6. Tray for microwave thawing of foodstuff per claim 2 characterized by the film of the polyester cover being a biaxial polyester film with a amorphous thermosealed polyester ply, an excellent barrier for oxygen, carbon dioxide, and water, high resistance to high and low temperatures, and microwave radiations do not interact with this polyester film.

7. Tray for microwave thawing of foodstuff per claim 2, characterized by the cavities where the foodstuff will be placed having two vertical slots in order to introduce the Japanese chopsticks and to make holding sushi easier, and communication channels to and from adjacent cavities that allow for heat communication between them.

8. Tray for microwave thawing of foodstuff per claim 3, characterized by the cavities where the foodstuff will be placed having two vertical slots in order to introduce the Japanese chopsticks and to make holding sushi easier, and communication channels to and from adjacent cavities that allow for heat communication between them.

9. Tray for microwave thawing of foodstuff per claim 4, characterized by the cavities where the foodstuff will be placed having two vertical slots in order to introduce the Japanese chopsticks and to make holding sushi easier, and communication channels to and from adjacent cavities that allow for heat communication between them.

10. Tray for microwave thawing of foodstuff per claim 6, characterized by the cavities where the foodstuff will be placed having two vertical slots in order to introduce the Japanese chopsticks and to make holding sushi easier, and communication channels to and from adjacent cavities that allow for heat communication between them.

11. Tray for microwave thawing of foodstuff per claim 6, characterized by having its main ply made of dual orientation polyester and other plies laminated thereto:
*evoh:* etylene-vynil alcohol
*polyamide: (nylon)*
*polyolefin: *ethylene copolymer

12. Tray for microwave thawing of foodstuff per claim 11, characterized by the cavities where the foodstuff will be placed having two vertical slots in order to introduce the Japanese chopsticks and to make holding sushi easier, and communication channels to and from adjacent cavities that allow for heat communication between them.
